(19) United States
(12) Patent Application Publication
(10) Pub. No.: US 2003/0141961 A1
(43) Pub. Date: Jul. 31, 2003

(54) Removable, modular remote opening device for wheeled or tracked vehicles

(76) Inventor: Jade Asa Lee Hylton, Las Vegas, NV (US)

Correspondence Address: MICHAEL C. MAIER, 200 South Shore Court, Chanhassen, MN, 55317, US

(21) Appl. No.: 10/058,601

(22) Filed: Jan. 28, 2002

(51) Int. Cl. G05B 19/00

(52) U.S. Cl. 340/5.64; 340/5.71

(57) ABSTRACT

The present invention relates to an integrally attached, modular and removable remote opening device for a vehicle, such as a motorcycle, snowmobile, snowblower, all terrain vehicle and lawnmowers. The invention comprises a semi rigid, modularly connected combination of an actuator and a signal generator that are located in distinct locations one from another and provided in such a fashion so as to not interfere with operation of the vehicle. The modular connection and removeable attachment means provided with the components enables the operator to readily reposition the components for convenience of the use of the operator as well as provides the ability to replace components in the event they are defective or damaged without discarding the entire system.

### CROSS-REFERENCES TO RELATED APPLICATIONS

None.

### BACKGROUND AND SUMMARY OF THE INVENTION

The present invention is directed to a removable, modular and integrally connected remote opening device that can be readily fitted to and within the body of a vehicle. The device can be applied during manufacture of the vehicle or at some later time by the owner of the vehicle. The purpose of the instant invention is to provide the owner of such vehicles with the convenience, safety and security typically provided to owners of conventional garage door openers.

Remote opening devices have become popular over time as it permits the user of the vehicle to open a garage door or external door or closure to another structure or housing which is used to store vehicles during periods of non-use or maintenance. Such devices were largely popularized by conventional automobiles as such devices enabled the driver of the automobile to open the external garage door without exiting the automobile before entering the garage itself.

The benefits of such an occurrence are obvious, particularly in times of inclement weather such as rain, hail or snow or even in climates that experience extreme cold or heat. However, other vehicles or human conveniences have not been provided with such devices and as such what is needed is a device that readily can be adapted to the vehicle structure without creating operating encumbrances, which may effect performance of the vehicle itself.

Conventional remote opening devices do not readily lend themselves to use with such vehicles and can in fact create a hazard to the vehicle operation. The problem with such devices is that the owner must remember where the opener is if he or she is to use it with another vehicle. Forgetting the opener can give rise to being locked out of one's home or worse, forcing the owner to active the door from inside the garage and then quickly run outside while avoiding not only the door and the safety sensors so that the door will close but also physical injury. Worse yet, even if the operator of the vehicle has remember the remote device, he or she often must search for the device, thereby becoming distracted from operating the vehicle or machine. As used herein, vehicle refers to machines, vehicles having a track or two or more wheels, more specifically to motorcycle, motorized tricycles, snowmobiles, snow blowers, wheelchairs, traditional bicycles, lawnmowers, all terrain vehicles, quad runners and passenger and equipment conveyances.

Conventional remote opening devices typically comprise a transmitter that is housed in a structure that can be placed in the owner's pocket, purse, clipped to the vehicle visor or placed, loose elsewhere in the automobile. However, in the operation of a vehicle such as that referred to above, having to remember to take a loose floating object with the operator defeats the purpose of making the task of opening an external door effortless. In addition, such devices can create operational hazards, as the operator of a vehicle has to search through one's pockets or other belongings in order to find the device. This requires the operator to remove a hand from the steering column or operational handle thereby sacrificing safety in search of convenience.

Remote opening devices have been proposed in the past for vehicles such as motorcycles, but these units have been ineffective as they are wrapped or clumsily applied to the motorcycle and can be lost during operation due to vibration of the vehicle or riding over rough terrain. This creates another concern as the loss of the remote opening device can then give rise to theft or breaking into the owner's residence if the finder of the device is able to discover the address of the owner. Moreover, it has been found that such prior art devices can also interfere with the external operation of vehicle by interfering with the steering or operational column and even the comfort of the rider or operator themselves. In addition, such prior devices did not lend themselves readily to replacement or repair and often required that the owner discard the entire unit creating unnecessary expense and waste.

In the operation of vehicles such as motorcycles, motorized tricycles, bicycles or snowmobiles, maintaining control of the vehicle at all times is a paramount concern and as such a remote opener that is easy to use and that requires activation only by a single digit is believed to be a significant improvement over prior art devices as the remote opening device enables the operator's grasp to stay in contact with the steering column. In addition, having the ability to change or replace components, provides additional economies to the owner of the device through the ability to readily service defective parts and replace batteries used to power the signal generator or transmitter.

In the case of vehicles such as snowblowers and lawnmowers, once the operator exits the garage or other enclosure, typically, the operator wants the external door to the enclosure shut so that snow or lawn clippings are not blown into the enclosure or heat or cool air lost from the enclosure to the outside. Moreover, in the case of operating a snowblower, searching for a remote opener in one's pocket with gloves or mittens can be quite clumsy if not completely frustrating in that the operator must remove his or her gloves to locate the device. However, having an integrally connected, modular and removable remote-opening unit in operative association with the operation handle enables the user to keep the unit engaged while opening the external door. This is particularly helpful with self-propelled snowblowers or lawn mowers as disengagement with the operational handle disables the propelling feature making pushing the snowblower or lawnmower an arduous task. Furthermore, having a modular, removable assembly provides additional convenience to the operator as if a portion of the unit is damaged by debris it can be readily and easily replaced.

What is needed therefor is a remote opening device, which is integrally connected to a vehicle while providing the convenience of modular assembly and removability and which can effectively open an external door to a garage or other enclosure without suffering from the foregoing difficulties and provide convenience and safety to the user and operator of the vehicle.

In a presently preferred embodiment of the instant invention a removable, modular and integrally attached remote opening device for a vehicle is provided and comprises a variably positionable actuator which is disposed on a steering column at a first location. A signal generator is operatively connected to the actuator at a second location remote from the first location. The signal generator is integrally, yet removably attached at the second location. First and second attachment means are provided for connecting the actuator and the signal generator to one another in such a way as to enable an operator of the vehicle to operate the remote opening device without releasing a grasp of the steering column.

In additional preferred embodiments, each of the signal generator and actuator are provided with protective housings and are connected one to another by a semi rigid wire. The connection is established through the use of male and female connectors that enable the components to be replaced in the event of malfunction. The signal generator or transmitter is a radio frequency or “RF” signal generator. The protective housings are connected to the vehicle through the use of fasteners and can be positioned so as to be concealed within the vehicle housing. The housings for each of the components are different in size and dimension from one another and are positioned remotely from each another.

In a still further preferred embodiment of the present invention a modular, integrally connected, modular remote opening device for a vehicle is described and comprises, a vehicle having a first dimension and a second dimension, with the first dimension equal to a distance between a surface supporting the vehicle and an upper most portion vertically disposed from the surface, and the second dimension equal to a distance between a most forward portion of the vehicle and a most rearward portion of the vehicle. An actuator is provided and has at least- a semi rigid housing and is removably connected to the vehicle and is disposed at a first location in easy proximity to an operator's control. A signal generator having at least a semi rigid housing is sized and configured to be distinct from the rigid housing of the actuator is removably connected to the vehicle and is disposed at a second location distinct from the first location. The actuator and the signal generator are connected to one another through a semi rigid cable having a modular connection disposed therein. The modular connection having at least one male and at least one female connector which cooperate with one another to form said modular connection. The first location is spaced a distance from the second location by a distance equal to at least the first dimension but less than the second dimension of the vehicle and the semi rigid cable with the modular connector being approximately equal to the distance.

These, as well as other objects and advantages of this invention, will be more completely understood and appreciated by referring to the following more detailed description of the presently preferred exemplary embodiments of the invention in conjunction with the accompanying drawings

### BRIEF DESCRIPTION OF THE DRAWINGS

FIG. 1 is a font view of the remote opening device of the present invention;

FIG. 2 is a side view of the remote opening device of the present invention; and

FIG. 3 is a side view of the remote opening device of the present invention showing the integral connection of the invention to a vehicle.

These and other objects of the invention will become clear from an inspection of the detailed description of the invention and from the appended claims.

### DETAILED DESCRIPTION OF THE INVENTION

The present invention is illustrated in greater detail by way of the following embodiments, but it should be understood, that the present invention is not to be construed as being limited thereto.

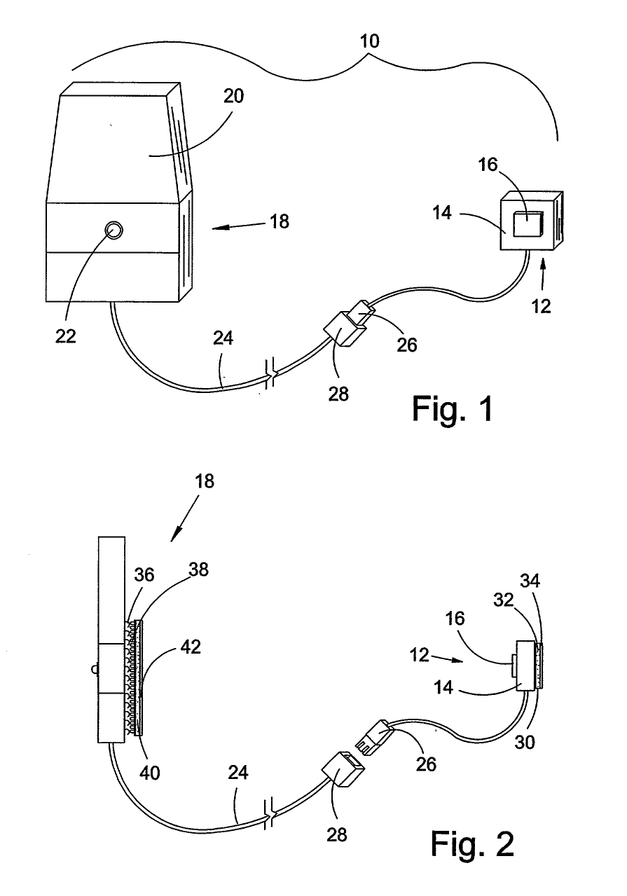

FIG. 1 of the present invention shows the remote opening device generally at 10, and includes the actuator 12, having a rigid or semi rigid housing 14 and a button 16. The housing may be made of any suitable material such as plastic, fiberglass or metal but in the preferred embodiments of the present invention plastic is preferred. The button 16 is resiliently biased by a spring or other flexible element (not shown) so that the button 16 can be pressed to actuate the device and then returned to an inoperative position. The button 16 is sized and configured so as to be about the size of a human digit. The housing 14 is of such a size as to not interfere with the operation of any mechanical components, which surround the actuator 12.

The signal generator or signal transmitter is shown generally by reference numeral 18 is also depicted in FIG. 1. The signal generator is enclosed in a housing 20 and the housing may be made of any suitable material such as plastic, fiberglass or metal but in the preferred embodiments of the present invention plastic is preferred. Embedded in the housing is an indicator light 22 which shows when a signal has been generated by actuation of the actuator 12 through depressing button 16.

The signal generator 18 and the actuator 12 are connected to one another through a semi rigid cable or wire 24. The wire or cable 24 is attached to the signal generator 18 and actuator 12 by conventional means such as welding or other operative connection such as by “plug-in” type connectors. The signal generator 18 and actuator 12 are brought into operative engagement through the use of a male 26 and female connector 28. Through the use of these modular male 26 and female 28 elements, either element, the signal generator 18 or the actuator 12 may be replaced if is becomes defective or damaged in use. This provides an additional advantage for the present invention in that the entire assembly 10 does not need to be discarded or replaced in the event of a signal unit failure or even failure or breakage of a portion of the cable or wire 24.

The signal created by the signal generator 18 after actuation by the actuator 12 is a radio frequency (“RF”) signal which remotely actuates an externally operative closure for a protective housing (not shown) such as a garage or shed used in regularly storing such devices.

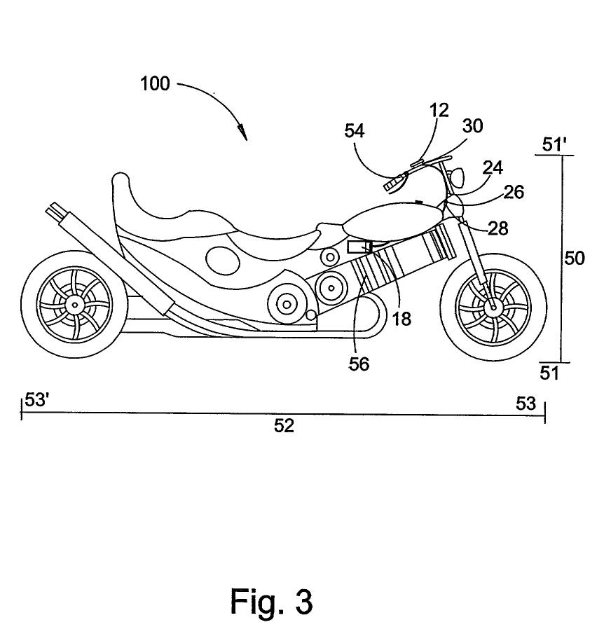

FIG. 2 depicts a side view of the invention and illustrated the attachment means. Actuator 12 is provided with an adhesive attachment means 30, which includes generally a permanent adhesive 32 to securely fasten the actuator 12 to a component of a vehicle 100 (shown in FIG. 3). The permanent adhesive 32 is covered by a release liner 34, which is removed prior to installing the actuator 12 on the vehicle 100. In addition to a permanent adhesive, a removable adhesive may be used in order to permit the operator of the device to readily reposition the actuator 12 to another portion of the vehicle 100 to increase ease of operation and use. Attachment means 30 enables the actuator 12 to be moved for greater flexibility and to enable use of the invention 10 without interfering with operation of the vehicle.

The signal generator 18, is a battery powered generator and uses conventional batteries, such as Eveready® or Duracell®, and is provided in the preferred embodiment with a hook 36 and loop 38 type fastener, commonly sold under the trademark VELCRO® or similar fastener having mushroom shaped pegs and loops and sold under the tradename 3M™ Dual Lock™ Reclosable Fasterners. As used herein, hook and loop type fasteners refer to each of the foregoing types of fasteners as well as equivalent structures including but not limited to male and female closure devices. The hook 36 and loop 38 faster is usually provided with an adhesive backing 40 that is covered by a removable release liner 42 that is removed prior to installation. Use of such an attachment means permits the operator of the vehicle 100 to remove the signal generator 18 from the location on the vehicle 100 that it is installed, for purposes of making repairs or replacing the battery. In addition, use of such an attachment means also provides the owner with additional security as the owner can quickly and easily remove the signal actuator 18 if the vehicle is left outside a protective enclosure.

In addition to the attachment means described above for each of the actuator 12 and signal generator 18, other attachment means may be provided, such as threaded fasteners, welding, glue and even fabrication of the components directly into elements of the vehicle itself.

Referring now to FIG. 3, the vehicle 100 is illustrated with the actuator 12 and signal generator 18 installed on the vehicle 100. The vehicle 100 has a first dimension 50, which extends from the surface 51 that supports the vehicle (road, garage floor, etc.) to the uppermost portion of the vehicle 100 extending in the vertical plane 51′. The vehicle 100 has a second dimension 52 which extends from the most forward portion 53 of the vehicle 100 to the most reward portion 53′.

The actuator 12 is installed on the vehicle 100, in the preferred embodiment on the steering column or handle bar 54 through attachment means 30. The signal generator 18 is connected to the vehicle 100 through the hook and loop fastener 36, 38, preferably in a concealed location and in an area which will not cause damage to the operative components of the vehicle such as on the external surface of the radiator 56. As shown in FIG. 3, the locations of the installation points are distinct from one another. The distance apart the two elements 12 and 18 are spaced, as well as the length of the cable or wire 24 is at least equal to the dimension 50 of the vehicle 100 but not greater than the dimension 52 of the vehicle 100.

The vehicle 100 illustrated in FIG. 3 is a motorcycle, but it is to be understood that the present invention 10 is applicable to all sorts of vehicles or devices typically not fitted with remote opening devices. This includes snowmobiles, snow blowers and lawn mowers, both riding and push types, all terrain vehicles (commonly referred to as “ATVs”) “quad runners” and the like.

It will thus be seen according to the present invention a highly advantageous remote opening device has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A removable, integrally attached remote opening device for a vehicle, comprising;
a variably positionable actuator disposed on a steering column at a first location;
a signal generator operatively connected to said actuator at a second location remote from said first location, said signal generator being integrally, yet removably attached at said second location;
first and second attachment means for connecting said actuator and said signal generator; and
wherein an operator of said vehicle can operate said remote opening device without releasing a grasp of the steering column.

2. A remote opening device for a vehicle as recited in claim 1, wherein, said first and second attachment means are distinct from one another.

3. A remote opening device for a vehicle as recited in claim 1, wherein said second attachment means is a hook and loop type fastener.

4. A remote opening device for a vehicle as recited in claim 1, wherein said first attachment means uses a permanent adhesive.

5. A remote opening device for a vehicle as recited in claim 1, wherein said signal actuator is concealed within a protective housing.

6. A remote opening device for a vehicle as recited in claim 5, wherein said protective housing is constructed of plastic.

7. A remote opening device for a vehicle as recited in claim 1, wherein said signal actuator generates an RF signal.

8. A remote opening device for a vehicle as recited in claim 1, wherein said signal actuator is housed within the vehicle.

9. A remote opening device for a vehicle as recited in claim 1, wherein said actuator and said signal generator are operatively connected via a semi rigid cable.

10. A remote opening device for a vehicle as recited in claim 9, wherein said semi rigid cable is provided with a male and a female connector.

11. A remote opening device for a vehicle as recited in claim 1, wherein each of said actuator and said signal generator are provided with a rigid housing.

12. A remote opening device for a vehicle as recited in claim 11 wherein said actuator housing is sized and configured having a first dimension and said signal generator is sized and configured having a second dimension distinct from said first dimension.

13. A remote opening device for a vehicle as recited in claim 1, wherein the vehicle has more than two wheels.

14. A remote opening device for a vehicle as recited in claim 1, wherein the vehicle is a two wheeled vehicle.

15. A remote opening device for a vehicle as recited in claim 14, wherein said two wheeled vehicle is a motorcycle.

16. A remote opening device for a vehicle as recited in claim 1, wherein said two wheeled vehicle is a snow blower.

17. A remote opening device for a vehicle as recited in claim 1, wherein said vehicle is a vehicle having a track.

18. A remote opening device for a vehicle as recited in claim 17, wherein said tracked vehicle is a snow mobile.

19. A remote opening device for a vehicle as recited in claim 17, wherein said tracked vehicle is a snow blower.

20. A modular, integrally connected, removable remote opening device for a vehicle, comprising;
a vehicle having a first dimension and a second dimension, said first dimension equal to a distance between a surface supporting said vehicle and an upper most portion vertically disposed from the surface, and said second dimension equal to a distance between a most forward portion of the vehicle and a most rearward portion of the vehicle;
an actuator having at least a semi rigid housing and removably connected to said vehicle and disposed at a first location in easy proximity to an operator's control;
a signal generator having at least a semi rigid housing and sized and configured to be distinct from said rigid housing of said actuator being removably connected to said vehicle and disposed at a second location distinct from said first location;
said actuator and said signal generator connected to one another through a semi rigid cable having a modular connection disposed therein;
said modular connection having at least one male and at least one female connector which cooperate with one another to form said modular connection; and
wherein said first location is spaced a distance from said second location by a distance equal to at least said first dimension but less than said second dimension of the vehicle and said semi rigid cable with said modular connector being approximately equal to said distance.
